(19) United States
(12) Patent Application Publication
(10) Pub. No.: US 2015/0319587 A1
(43) Pub. Date: Nov. 5, 2015

(54) SHORT MESSAGE SERVICE IN PROSE

(71) Applicant: INTERDIGITAL PATENT HOLDINGS, INC., Wilmington,, DE (US)

(72) Inventors: Behrouz Aghili, Commack, NY (US); Mahmoud Watfa, Saint Leonard (CA); Ulises Olvera-Hernandez, Kirkland (CA)

(73) Assignee: INTERDIGITAL PATENT HOLDINGS, INC., Wilmington, DE (US)

(21) Appl. No.: 14/440,206

(22) PCT Filed: Oct. 30, 2013
(86) PCT No.: PCT/US13/67508

§ 371 Date: May 1, 2015

Related U.S. Application Data
(60) Provisional application No. 61/721,778, filed on Nov. 2, 2012.

(51) Int. Cl. H04W 4/14; H04W 8/02

(52) U.S. Cl. CPC H04W 4/14; H04W 8/02

(57) ABSTRACT

Methods and systems are disclosed for delivering SMS messages while reducing the signaling overhead within a cellular CN. For example, an SMS originating WTRU may send an indication to a RAN entity, and the indication may indicate that an SMS recipient WTRU is in the same relative geographical area as the originating WTRU. The originating WTRU may send the SMS message to the RAN entity. The SMS message may indicate that the recipient WTRU is an intended destination of the SMS message. Methods and systems are disclosed for an SMS anchor node to deliver an SMS message. For example, the SMS anchor node may receive an indication that a WTRU is in the same general geographical area as a originating WTRU. The SMS anchor node may deliver the SMS message to the recipient WTRU without utilizing a SMS Service Center SC to route the SMS message.

### CROSS-REFERENCE TO RELATED APPLICATIONS

This application claims the benefit of U.S. Provisional Patent Application No. 61/721,778, titled “Short Message Service In PROSE”, filed Nov. 2, 2012, the entire contents of which being hereby incorporated by reference as if fully set forth herein, for all purposes.

### BACKGROUND

The Short Message Services (SMS) was originally defined for the Global System for Mobile communications (GSM) during the early 1990s. Since that time, SMS has evolved, for example to make the service feasible in General packet radio service (GPRS) networks, Universal Mobile Telecommunications System (UMTS) networks, Evolved Packet System (EPS) networks (e.g., Long Term Evolution (LTE) networks), etc. However, several fundamental concepts have persisted irrespective of the network(s) over which SMS has been implemented. For example, in many networks a mobile device (e.g., wireless transmit/receive unit (WTRU)) may communicate with a Core Network entity at a first level of a communication protocol stack and with an SMS Service Center (SC) at another (e.g., second) level of the communication protocol stack in order to successful send and/or receive SMS messages.

### SUMMARY

Methods and systems are disclosed for delivering SMS messages while reducing the signaling overhead within a cellular core network (CN). For example, a method implemented by a SMS originating wireless transmit receive unit (WTRU) for sending a short message service (SMS) message may include sending an indication to a radio access network (RAN) entity. The indication may indicate that an SMS recipient WTRU is in the same relative geographical area as the originating WTRU. The method may include sending the SMS message to the RAN entity. The SMS message may indicate that the recipient WTRU is an intended destination of the SMS message.

In some embodiments, the indication may be sent as part of the SMS message. For example, the indication may be included in a radio resource control (RRC) portion of the SMS message. If the RAN entity is a Global System for Mobile Communications (GSM) Enhanced Data rates for GSM Evolution (EDGE) radio access network (GERAN) entity, the indication may be included in one or more bits in a Layer 2 GSM message. The layer 2 GSM message may be a Link Access Procedures on the Dm Channel (LAPDm) message.

The originating WTRU and/or the recipient WTRU may determine that its communication peer is a proximity services (PROSE) candidate based on communication peer being in the same relative geographical area as the originating WTRU and/or the recipient WTRU. The originating WTRU and/or the recipient WTRU may determine that the communication peer is a PROSE candidate based on the communication peer being served by the RAN entity that also serves the originating WTRU and/or the recipient WTRU. The originating WTRU and/or the recipient WTRU may determine that a communication peer is a PROSE candidate based on local communications exchanged with the communication peer. The originating WTRU and the recipient WTRU may communicate using a local communication channel. The communications using the local communication channel may utilize one or more of Bluetooth communications, Wi-Fi communications, and/or Near Field Communications (NFC).

The originating WTRU may receive an acknowledgement from a SMS anchor node after the SMS message has been successfully delivered. In an example, the anchor node may be a different node than an SMS Service Center (SC). For example, the anchor node may be the RAN entity. The RAN entity may be one of a base station controller (BSC), a radio network controller (RNC), or an evolved Node B (eNB). In an example, the anchor node may be a core network (CN) entity. The CN may be one of a mobile switching center (MSC), a Serving General packet radio service (GPRS) Gateway Node (SGSN), or a mobility management entity (MME).

Methods and systems are disclosed for a short message service (SMS) anchor node to deliver an SMS message. For example, the SMS anchor node may receive an indication that a recipient wireless transmit receive unit (WTRU) is in the same general geographical area as a originating WTRU. The SMS anchor node may deliver the SMS message to the recipient WTRU without utilizing a SMS Service Center (SC) to route the SMS message. The SMS anchor node may de-encapsulate Relay Protocol (RP)-DATA from Control Protocol (CP)-DATA included in a non-access stratum (NAS) message. The SMS anchor node may encapsulate the RP-DATA in a new CP message for delivery to the recipient WTRU.

The SMS anchor node may send an RP-ACK message to the originating WTRU. The RP-ACK message may be sent in response to receiving an acknowledgment from the recipient WTRU indicating that the recipient WTRU has successfully receiving the new CP message. The SMS anchor node may send a delivery indication for the SMS message to the SC. The delivery indication may indicate that the SMS message has been delivered. The SMS anchor node may refrain from including the SMS message in the delivery indication.

The SMS anchor node may store the SMS message. The SMS anchor node may re-attempt to deliver the SMS message based on the recipient WTRU being unavailable during a first attempted delivery. The SMS anchor node may send the SMS message to the SC for delivery based on the SMS message failing to be delivered to the recipient WTRU for a predetermined amount of time after receiving the SMS message. The SMS anchor node may send the SMS message to the SC for delivery based on an occurrence of a predetermined number of failed delivery attempts. The SMS anchor node may be a RAN node and/or a CN node.

Embodiments contemplate a core network (CN) node. The CN node may be in communication with a radio access network (RAN) node. The RAN node may be in communication with a wireless transmit/receive unit (WTRU). The CN node may comprise a processor. The processor may be configured, at least, to receive a first short message service (SMS) message from the RAN node. The first SMS message may include at least an indication that a recipient WTRU may be served by the RAN node. The recipient WTRU may be identified to the RAN node by the WTRU as a proximity service (PROSE) candidate. The first SMS message may also include control protocol data (CP-Data) that includes relay protocol data (RP-Data). The CP-Data that includes the RP-Data may be forwarded from the WTRU to the RAN node. The processor may also be configured to extract the RP-Data from the CP-Data. In some embodiments, the process may be further configured to determine to send a relay-protocol acknowledgement (RP-ACK) to the WTRU. The processor may be configured to send a control protocol acknowledgement (CP-ACK) to the WTRU. The processor may be configured to send a second SMS message to the WTRU, where the second SMS message may include at least CP-Data that includes the RP-ACK.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of another example radio access network and an example core network that may be used within the communications system illustrated in FIG. 1A;

FIG. 1E is a system diagram of another example radio access network and an example core network that may be used within the communications system illustrated in FIG. 1A;

FIG. 2 illustrates an example system architecture for SMS transfer, consistent with embodiments;

FIG. 3 illustrates an example protocol layer overview for SMS, consistent with embodiments;

FIG. 4 illustrates an example signal flow for SMS communication for use with PROSE, consistent with embodiments; and

FIG. 5 illustrates an example signal flow for SMS communication for use with PROSE, consistent with embodiments.

### DETAILED DESCRIPTION OF ILLUSTRATIVE EMBODIMENTS

A detailed description of illustrative embodiments will now be described with reference to the various Figures. Although this description provides a detailed example of possible implementations, it should be noted that the details are intended to be examples and in no way limit the scope of the application.

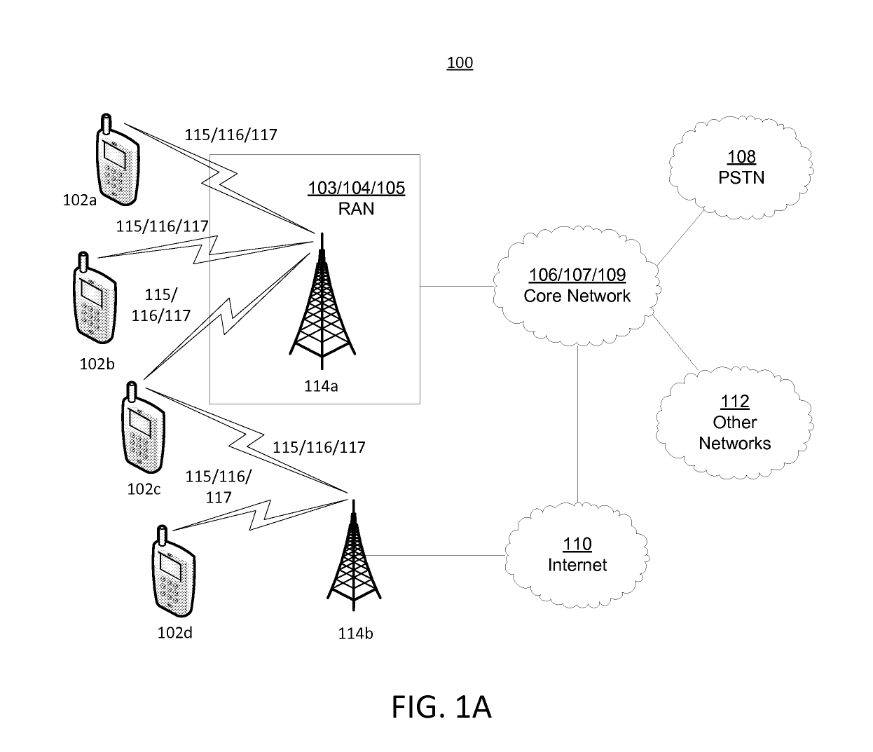

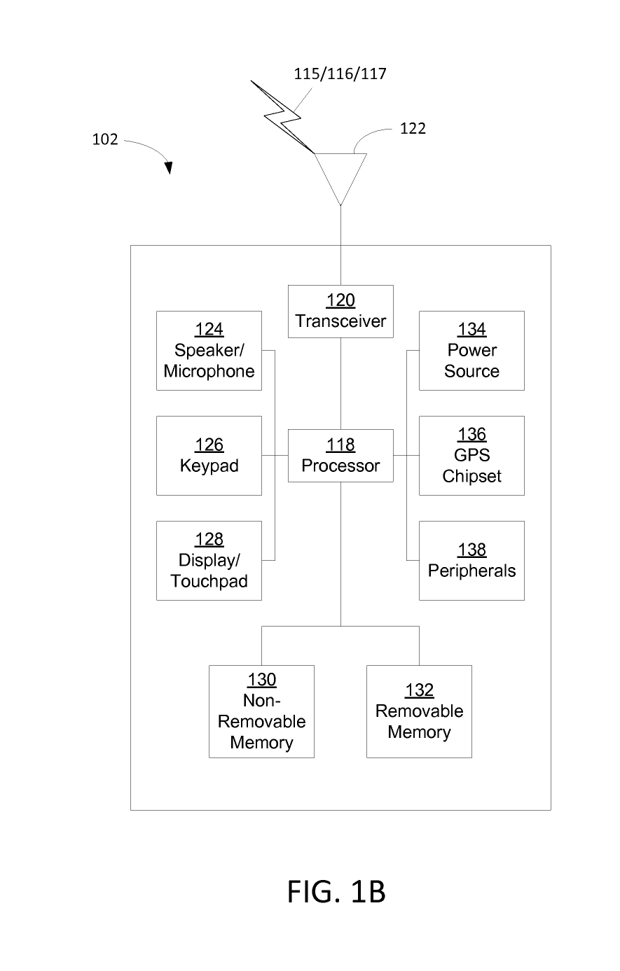

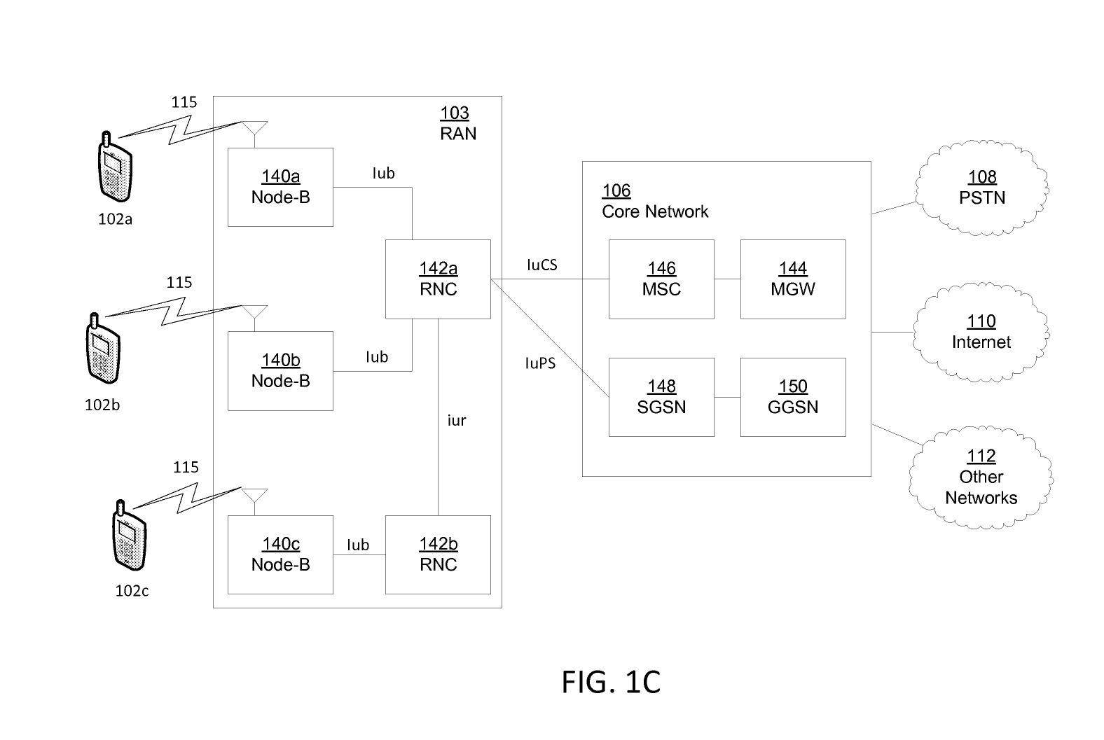

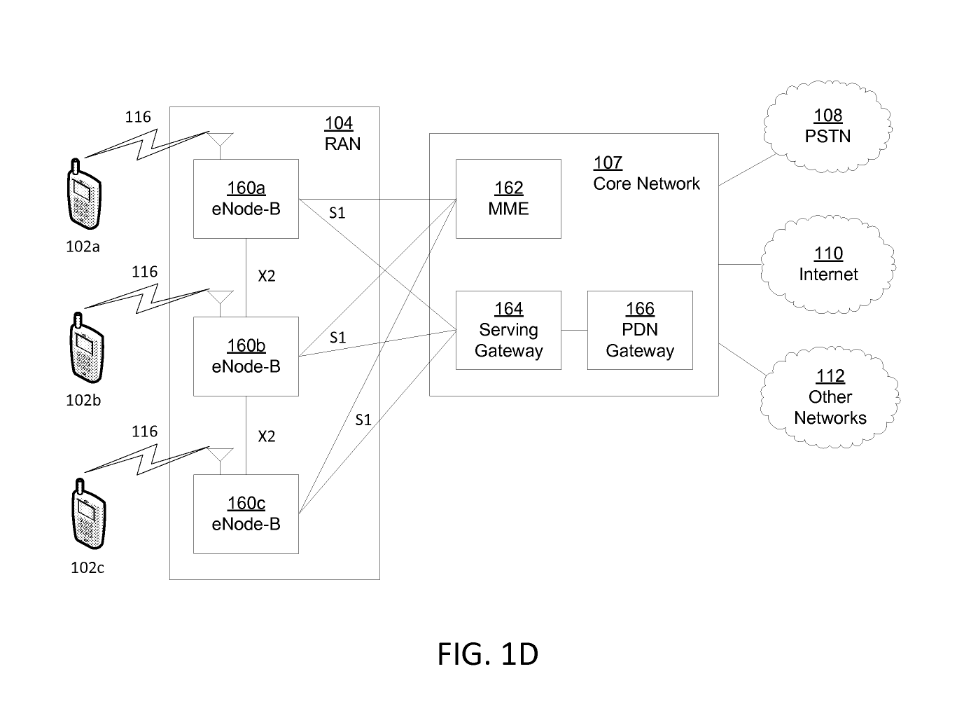

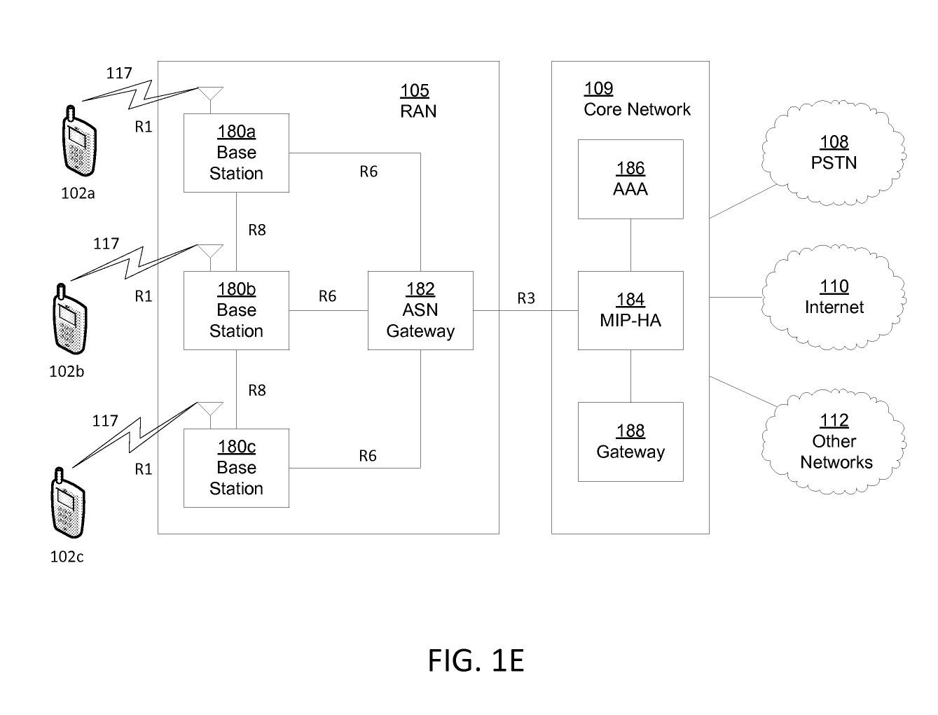

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Embodiments recognize that proximity-based Services (aka “PROSE”) have become an area of increased interest. For example, PROSE may be used by a WTRU to discover instances of applications running on other devices that are in the proximity of the WTRU. The WTRU and the other devices may locally exchange data that supports the common applications. As an example, a WTRU may determine that other mobile devices may be residing in a close area/range and that those devices may be candidates for local communication to support applications executing on the WTRU. A point-to-point communication session may be established between the devices, for example either a direct device-to-device communication method and/or through a radio access network (RAN), which may bypass the associated core network(s).

The systems and methods described herein may be utilized to deliver SMS messages between WTRUs while reducing the signaling load within a cellular network. For example, WTRUs that are in the same general geographical area may be configured to exchange SMS messages using simplified signaling paths based on the fact that they are near each other. For example, PROSE may be used to discover local WTRUs that may exchange data using direct, local communication channels or via simplified signaling through a shared RAN. The signaling using the shared RAN may allow the RAN to refrain from sending one or more messages to a CN due to the fact that the RAN has determined that both of the communication peers are served by the RAN. When used herein, the terms local communication peer, local WTRU, PROSE candidate, and/or the like may be used to describe a WTRU/device that is in the same general geographic vicinity as another WTRU for which operable communication is desired.

Embodiments recognize that local communication may refer to direct communications between the devices and/or to communications that may utilize a common RAN but might not trigger one or more messages to be transmitted in a CN which may be transmitted when a WTRU attempts to connect to the RAN. For example, since the RAN node (e.g., BSC, RNC, eNB, etc.) may know that both communication peers are served by the RAN node, it may omit signaling that may be sent within the core network, perhaps in order to deliver a message to a device whose current location may be unknown to the RAN node. For example, in the case of SMS messages, among other scenarios, the RAN node and/or a CN node may refrain from forwarding the SMS message to the SMS SC for delivery.

Embodiments recognize that SMS service may be defined between a WTRU and the SC. For example, the SC may store messages sent by a WTRU and/or may forward the messages on behalf of the WTRU to their intended destination (e.g., another mobile device). The SC may store the message and/or re-attempt delivery, perhaps immediately and/or at a later time, for example if the recipient might not be currently available. An SC may support mobile terminated (MT) messaging (e.g., for messages sent to a WTRU) and/or mobile originating (MO) messaging (e.g., for those sent from the WTRU) operations. The SC may provide confirmations to the originating device, for example perhaps when the SMS has been delivered.

For example, the SC may acknowledge receipt of the message, for example when an SC may receive a mobile originated SMS message from the WTRU. A relay protocol (RP) may be used to coordinate acknowledgements sent from the SC to the WTRU (or vice versa). For example, a WTRU may send an SMS message to the SC for delivery. The data associated with the SMS message may be included in a “RP-DATA” portion of the message. The WTRU may address the SMS message data (e.g., RP-DATA) to the SC.

In some embodiments, the SC may acknowledge receipt of the SMS message, for example by responding with an RP-ACK, perhaps upon reception of the message including the RP-DATA, among other scenarios. The WTRU may determine that reception of the SMS message has been acknowledged at two separate layers of the protocol hierarchy, for example when the WTRU may receive the RP RP-ACK. For example, another protocol layer referred to as the Control Protocol (CP) layer may be utilized, for example between the WTRU and the anchor point on the core network side (e.g., MSC/SGSN). The CP protocol entity in the network may be considered to be at the NAS level of the mobile network protocol stack and/or may be referred to as the SMS Entity. Perhaps similar to the RP messages, CP messages may include the SMS message payload in a CP-DATA field. Alternatively or additionally, the CP protocol entity (e.g., in the MSC/SGSN) may send a CP-ACK to the WTRU, for example upon receipt of the CP-DATA, among other scenarios.

In some embodiments, a WTRU may send an SMS message to another mobile device. The WTRU may add the associated “RP” header to the SMS data, for example perhaps when constructing the message, among other scenarios, which may be included in the RP-DATA field of the RP message. The RP message may be addressed for the SC that serves the WTRU. In some embodiments, perhaps since the WTRU may first send the SMS message to the MSC/SGSN (e.g., which forwards the SMS message to the SC), among other scenarios, the WTRU may encapsulate the RP message into a CP-DATA field of a CP message and/or send the CP message to the MSC/SGSN.

The MSC/SGSN may receive the CP message including the CP-DATA. The MSC/SGSN may acknowledge its reception of the CP message by sending a CP-ACK back to the WTRU. The MSC/SGSN may extract the RP-DATA (e.g., from the CP-DATA) and/or may send the extracted RP-DATA to the SC. The SC may send an RP-ACK back to the WTRU, for example when it receives the RP message. The RP-ACK may be encapsulated in a CP-DATA field of a CP message and sent to the WTRU, for example when RP-ACK reaches the MSC/SGSN, among other scenarios. The WTRU may determine that the SMS has been successfully received by the SC, for example perhaps based, at least in part, on the receipt of the encapsulated RP-ACK in the CP message. The WTRU may send a pure CP-ACK (e.g., which may be the acknowledgement for the received CP-DATA including the RP-ACK) back to the MSC/SGSN to acknowledge receipt of the CP message that included the RP-ACK.

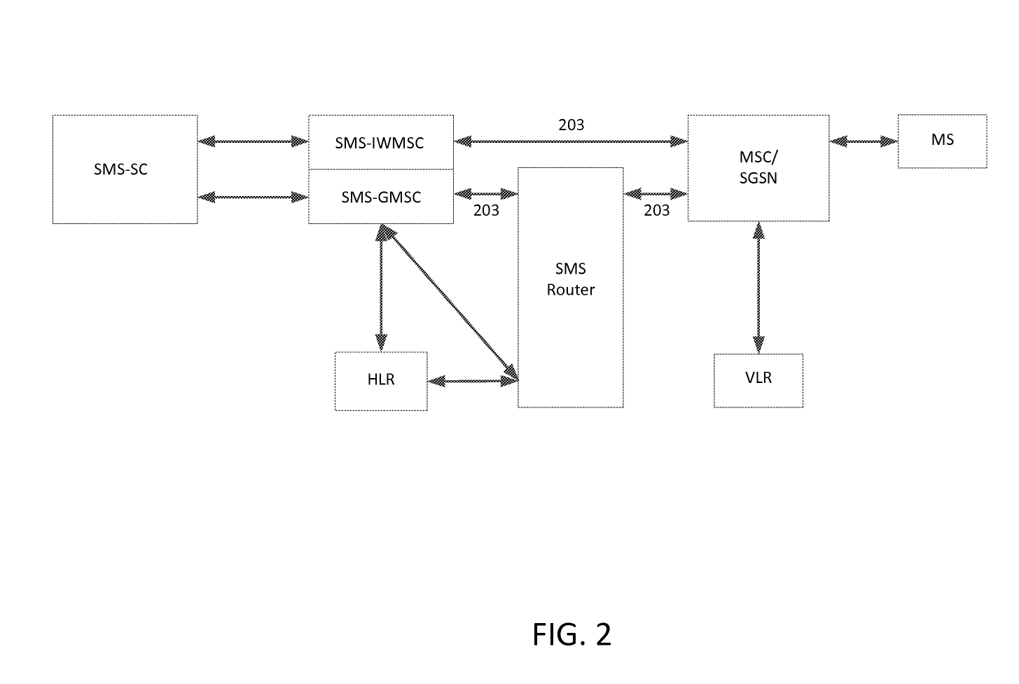

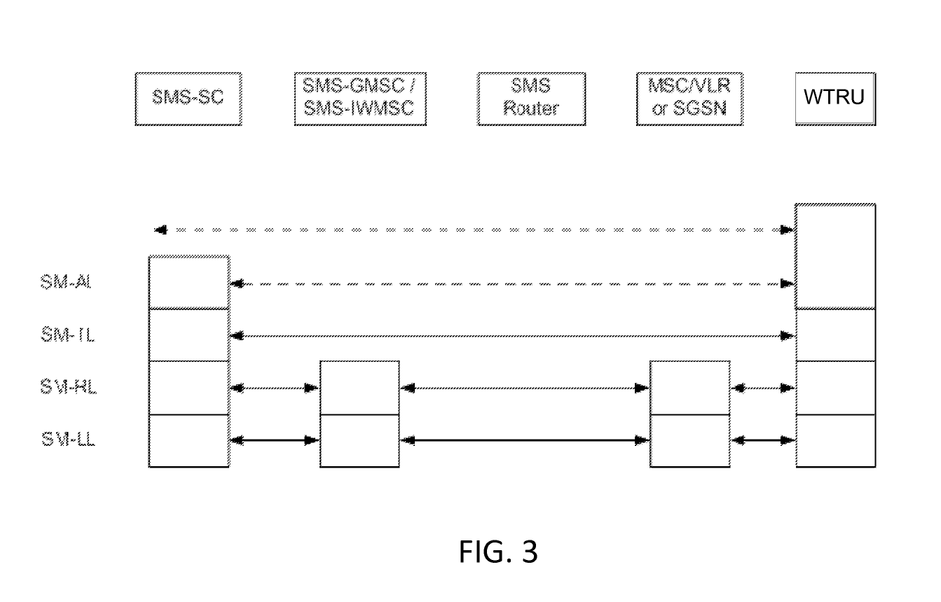

FIG. 2 illustrates an example architecture for implementing an SMS transfer. The MSC/SGSN may support/utilize the RP layer in order to communicate with SC and/or SMS interworking MSC (SMS-IWMSC). The SMS Router may be may be present or may be absent. If it is not present, reference point 203 may extend from the SMS-Gateway Mobile Switching Center (SMS-GMSC) directly to the MSC/SGSN. FIG. 3 illustrates an example protocol layer overview for SMS. For example, SM-LL may refer to the Small Message-Link Layer, SM-RL may refer to the Short Message Relay Layer, SM-TL may refer to the Short Message Transfer Layer, and/or SM-AL may refer to the Short Message Application Layer (SM-AL). For example, RP functionality may be implemented at the SM-RL.

Embodiments recognize that SMS traffic may involve one or more core NW entities (e.g., MSC/SGSN) and the SMS-SC. Embodiments contemplate that with the advent of PROSE, one or more messages or acknowledgements that are exchanged within the core network may be modified and/or eliminated for SMS messages that are exchanged between WTRUs within the same general geographical area. For example, some of the SMS messages and/or acknowledgements may be treated and/or exchanged locally between the WTRUs. The local exchange may be a direct point-to-point communication between the devices and/or may involve the RAN without full routing/signaling by the core network.

For example, when used herein the term local communication may refer to communications between WTRUs that are exchanged without the use of a cellular network and/or communications which utilize the RAN of a cellular network without utilizing one or more, or all, of the more traditional signaling, acknowledgements, and/or routing that is typically utilized within the core network associated with RAN. In a sense, these local communications may make use of a common RAN for exchanging communications, although one or more, or all, of the communications within the core network that may be utilized to facilitate communication over the RAN may be omitted.

Several example scenarios may be utilized to illustrate the concept of local communications that utilize the RAN of a cellular network. For example, for SMS messages exchanged between WTRUs with PROSE (e.g., between WTRUs within the same general geographical area), the SMS traffic may be treated and processed at an MSC, an SGSN, and/or an MME, for example without utilizing the services of an SMS-SC. In another example, the SMS traffic may be treated and processed at a control entity in a RAN (e.g., BSC, RNC, eNB, etc.), for example without utilizing the services of an SMS-SC. In some embodiments the SMS-SC might not be used to determine how to route and/or deliver the SMS message. In such scenarios and others, the SMS-SC or some other SMS entity may still be notified when such messages are exchanged, for example for billing purposes, or the like.

In some embodiments, perhaps if the SMS transfer is to be controlled/terminated at the MSC, the SGSN, and/or the MME, among other scenarios, and/or where a RAN node (e.g., BSC, RNC, eNB, etc.) may receive an SMS message for which the recipient is served by the same RAN node, the RAN node may notify the MSC, the SGSN, and/or the MME that the SMS recipient is served by the same RAN node as serves the SMS originator. For example, an originating WTRU may have previously sent a message to the RAN that identified the recipient WTRU as a PROSE candidate. In an example, the originating WTRU may indicate that the recipient is a PROSE candidate in the SMS message, for example using a flag and/or information element in the RRC portion of the SMS (NAS) message. In some embodiments, one of the spare bits in the layer 2 protocol of GSM (e.g., LAPDm) may be used to indicate that the recipient WTRU is a PROSE candidate, for example perhaps if the access network is GERAN. The Radio Link Control (RLC) Data Blocks of the RLC//Medium Access Control (MAC) protocol can be modified to indicate that the recipient WTRU is a PROSE candidate, for example in the PS domain. For example, the indication may be signaled by adding a bit and/or IE to the RLC/MAC header.

The CN anchor point may determine to extract the RP-DATA that is encapsulated in the received CP-DATA, for example perhaps when the CN anchor point for the local SMS transmission (e.g., MSC, the SGSN, and/or the MME) may receive the SMS message. The CN anchor point may send the RP-DATA to the PROSE candidate that is the destination of the SMS message. For example, the CN anchor node may re-encapsulate the RP data in a new CP message and send the CP message to the recipient WTRU. The recipient WTRU may receive the CP message with the encapsulated RP-DATA and may send an acknowledgement back to the CN anchor node. The CN anchor node may send a new (e.g. fresh) RP-ACK to the originating WTRU, for example in response to receiving the acknowledgement from the recipient WTRU that may indicate that the SMS message has been successfully delivered. One or more messages used to pass the RP-DATA to the SC may be omitted, for example by using the CN anchor node (e.g., MSC, the SGSN, and/or the MME) to deliver the SMS message. The signaling traffic in the core network may be reduced.

In some embodiments, a RAN node (e.g., BSC, RNC, eNB, etc.) such as a RAN controlling entity may act as the anchor point for local SMS transmission. For example, perhaps if the SMS transfer is to be controlled/terminated at the RAN node, among other scenarios, when a RAN node (e.g., BSC, RNC, eNB, etc.) may receive an SMS message for which the recipient is served by the same RAN node, the RAN node may determine that the SMS recipient is served by the same RAN node as serves the SMS originator. For example, an originating WTRU may have previously sent a message to the RAN node that identified the recipient WTRU as a PROSE candidate. In some embodiments, the originating WTRU may indicate that the recipient is a PROSE candidate in the SMS message, for example using a flag and/or information element in the RRC portion of the SMS (NAS) message. In some embodiments, one of the spare bits in the layer 2 protocol of GSM (e.g., LAPDm) may be used to indicate that the recipient WTRU is a prose candidate, for example perhaps if the access network is GERAN. The RLC Data Blocks of the RLC/MAC protocol can be modified to indicate that the recipient WTRU is a PROSE candidate, for example in the PS domain. For example, the indication may be signaled by adding a bit or IE to the RLC/MAC header.

In some embodiments, the RAN node may determine to extract the RP-DATA that is encapsulated in the received CP-DATA, for example perhaps when the RAN node anchor point for the local SMS transmission (e.g., BSC, RNC, eNB, etc.) may receive the SMS message. The RAN node may send the RP-DATA to the PROSE candidate that is the destination of the SMS message. For example, the RAN node may re-encapsulate the RP data in a new CP message and send the CP message to the recipient WTRU. The recipient WTRU may receive the CP message with the encapsulated RP-DATA and may send an acknowledgement back to the RAN node. The RAN node may send a new (e.g., fresh) RP-ACK to the originating WTRU, for example in response to receiving the acknowledgement from the recipient WTRU that indicates that the SMS message has been successfully delivered. One or more messages that may be used to pass the RP-DATA to the SC and/or to core network node(s) (e.g., MSC, the SGSN, and/or the MME) may be omitted, for example by using the RAN node (e.g., BSC, RNC, eNB, etc.) to deliver the SMS message, which may reduce the signaling traffic in the core network.

In some embodiments, the RAN node that acts as an anchor point may inform the anchor point in the CN (e.g., MSC, the SGSN, and/or the MME) that the SMS transmission has occurred. For example, the notification may be provided to ensure that the subscriber for the transmitting and/or receiving WTRU is properly charged for delivery of the SMS message.

In some embodiments, perhaps irrespective of whether the anchor point is in the RAN or the CN, among other scenarios, the anchor point may be configured to store the SMS message, for example for delivery at a later time if the recipient WTRU is currently unavailable. The anchor point may store the message itself, or may send the message to another network node for storage. In an example, if SMS delivery using the local PROSE delivery technique is unsuccessful (e.g., the recipient WTRU is unavailable), the anchor node may send the SMS to the SC for delivery in a manner similar to a traditional text message. For example, an SMS anchor node may determine to send the SMS to the SC for delivery to the recipient WTRU, perhaps if PROSE delivery may be unsuccessful and/or a predetermined amount of time since it received the SMS message may have elapsed. In some embodiments, an SMS anchor node may determine to send the SMS to the SC for delivery to the recipient WTRU based on exceeding a predetermined number of failed delivery attempts. The anchor node may store the SMS message and may re-attempt delivery, perhaps immediately and/or at a later time.

In some embodiments, alternatively or additionally to sending the SMS message to a RAN node and/or CN anchor node for local delivery, the originating and recipient WTRUs may communicate using a direct WTRU to WTRU communication channel. For example, the WTRUs may communicate using Bluetooth, Wi-Fi, Near Field Communications (NFC), and/or the like to locally exchange data. For example, the local communication channel may be used transport the RP-DATA of the SMS message. The RP data may be included in a NAS message that is exchanged between the WTRUs over the local communication channel.

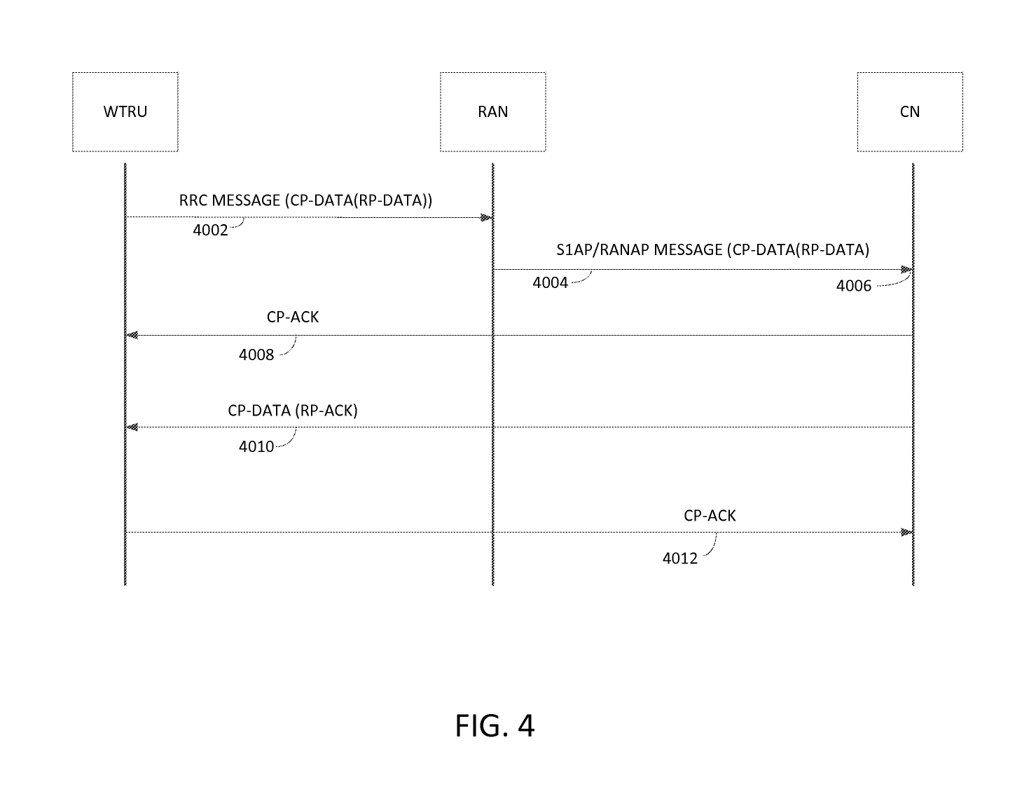

FIG. 4 illustrates an example signal flow diagram of SMS communication using PROSE functionality, including PROSE functionality at the core network (CN) entity. At 4002, the WTRU may indicate to the RAN entity that a receiver WTRU (not shown) is a PROSE candidate, perhaps in an RRC portion of an SMS message that may include CP-DATA, which may include RP-DATA. At 4004, the RAN entity may indicate in an SMS message to the CN entity that the receiver WTRU is served by the RAN entity. At 4006, the RP-DATA may be extracted from the CP-DATA at the CN entity. The CN entity may determine to send an RP-ACK to the WTRU, which in some embodiments may be included in a CP-DATA message (e.g., in an SMS message) from the CN entity at 4010. At 4008, the CN entity may send a CP-ACK (e.g., SMS message) to the WTRU. At 4012, the WTRU may send a CP-ACK (e.g., SMS message) to the CN entity.

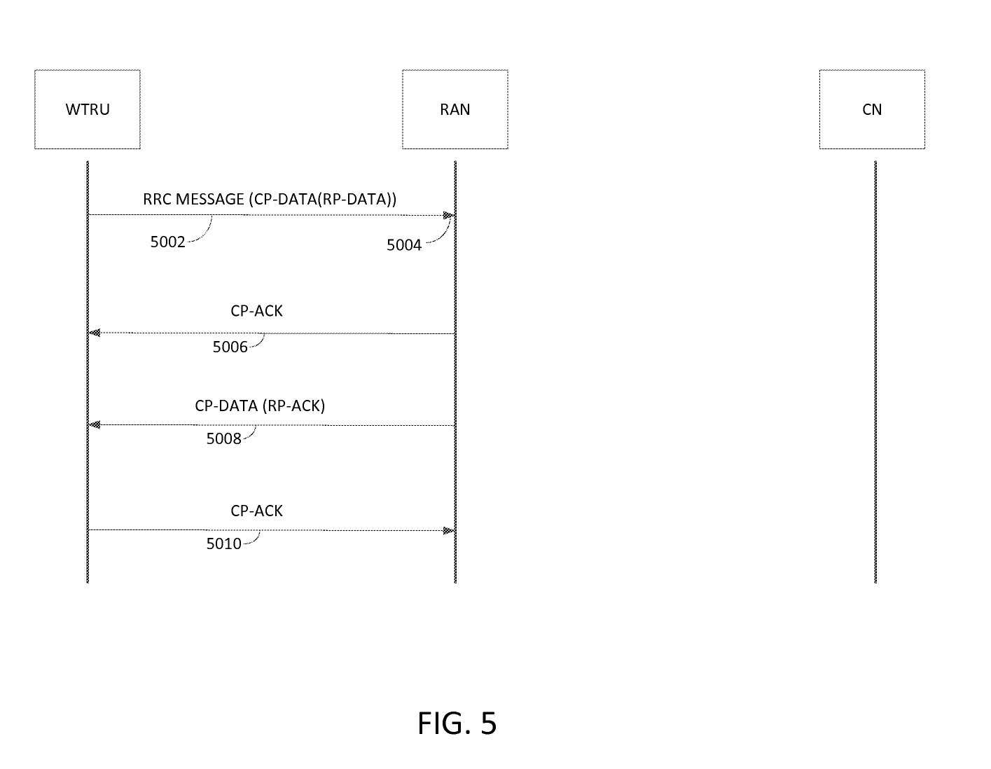

FIG. 5 illustrates an example signal flow diagram of SMS communication using PROSE functionality, including PROSE functionality at the RAN entity. At 5002, the WTRU may indicate to the RAN entity that a receiver WTRU (not shown) is a PROSE candidate, perhaps in an RRC portion of an SMS message that may include CP-DATA, which may include RP-DATA. At 5004, RP-DATA may be extracted from the CP-DATA at the RAN entity. The RAN entity may determine to send an RP-ACK to the WTRU, which in some embodiments may be included in a CP-DATA message (e.g., in an SMS message) from the RAN entity at 5008. At 5006, the RAN entity may send a CP-ACK (e.g., SMS message) to the WTRU. At 5010, the WTRU may send a CP-ACK (e.g., SMS message) to the RAN entity.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented by a radio access network (RAN) entity for communicating a short message service (SMS) message, the method comprising:
receiving a first indication at the radio access network (RAN) entity from an originator wireless transmit/receive unit (WTRU), the first indication indicating that a recipient WTRU is in the same relative geographical area as the originator WTRU;
receiving a second indication from the originator WTRU that the recipient WTRU is a proximity services (PROSE) candidate, the first indication and the second indication being sent as part of the SMS message;
determining that the originator WTRU and the recipient WTRU are both served by the RAN entity;
de-encapsulating Relay Protocol (RP)-DATA from Control Protocol (CP)-DATA included in the SMS message; and
sending the SMS message from the RAN entity, the SMS message indicating that the recipient WTRU is an intended destination of the SMS message.

2. (canceled)

3. The method of claim 1, wherein the first indication and the second indication is included in a radio resource control (RRC) portion of the SMS message.

4. The method of claim 1, wherein the RAN entity is a Global System for Mobile Communications (GSM) Enhanced Data rates for GSM Evolution (EDGE) radio access network (GERAN) entity, and the first indication and the second indication is included in one or more bits in a Layer 2 GSM message.

5. The method of claim 4, wherein the layer 2 GSM message is a LAPDm message.

6. (canceled)

7. (canceled)

8. (canceled)

9. (canceled)

10. The method of claim 1, further comprising sending an acknowledgement from a SMS anchor node after the SMS message has been successfully delivered.

11. The method of claim 10, wherein the anchor node is not an SMS Service Center (SC).

12. The method of claim 10, wherein the anchor node is the RAN entity.

13. The method of claim 12, wherein the RAN entity is at least one of: a base station controller (BSC), a radio network controller (RNC), or an evolved Node B (eNB).

14. A core network (CN) node, the CN node in communication with a radio access network (RAN) node, and the RAN node in communication with a wireless transmit/receive unit (WTRU), the CN node comprising:
a processor, the processor configured, at least, to:
receive a first short message service (SMS) message from the RAN node, the first SMS message including at least:
an indication that a recipient WTRU is served by the RAN node, the recipient WTRU identified to the RAN node by the WTRU as a proximity service (PROSE) candidate; and
control protocol data (CP-Data) that includes relay protocol data (RP-Data), the CP-Data that includes the RP-Data forwarded from the WTRU to the RAN node, and
extract the RP-Data from the CP-Data.

15. The CN node of claim 14, wherein the processor is further configured to:
determine to send a relay-protocol acknowledgement (RP-ACK) to the WTRU;
send a control protocol acknowledgement (CP-ACK) to the WTRU; and
send a second SMS message to the WTRU, the second SMS message including at least CP-Data that includes the RP-ACK.

16. A method for a short message service (SMS) anchor node to deliver an SMS message, the method comprising:
receiving an indication that a recipient wireless transmit receive unit (WTRU) is in the same general geographical area as a originating WTRU;
delivering the SMS message to the recipient WTRU without utilizing a SMS Service Center (SC) to route the SMS message;
de-encapsulating Relay Protocol (RP)-DATA from Control Protocol (CP)-DATA included in a non-access stratum (NAS) message; and
encapsulating the RP-DATA in a CP message for delivery to the recipient WTRU.

17. (canceled)

18. The method as in claim 16, further comprising sending an RP-ACK message to the originating WTRU.

19. The method as in claim 18, wherein the RP-ACK message is sent in response to receiving an acknowledgment from the recipient WTRU indicating that the recipient WTRU has successfully receiving the CP message.

20. The method as in claim 16, further comprising sending a delivery indication for the SMS message to the SC, wherein the delivery indication indicates that the SMS message has been delivered and does not include the SMS message.
